(19) United States
(12) Patent Application Publication
(10) Pub. No.: US 2003/0034961 A1
(43) Pub. Date: Feb. 20, 2003

(54) Input system and method for coordinate and pattern

(76) Inventor: Chi-Lei Kao, Taipei (TW)

Correspondence Address: J.C. Patents, Inc., Suite 114, 1340 Reynolds Ave., Irvine, CA, 92614, US

(21) Appl. No.: 09/932,626

(22) Filed: Aug. 17, 2001

(51) Int. Cl. G09G 5/00

(52) U.S. Cl. 345/179

(57) ABSTRACT

An input system for coordinate and pattern includes a pen and a photographic device affixed on the pen, suitable for use on a panel. The photographic device can photograph the panel by a photographic image region and is coupled to a control unit. According to the image pattern of the photographic image region, an image discerning analysis is performed for detecting the coordinate of the photographic image region. The displacement, speed, handwriting, and direction can also be analyzed out. Moreover, the photographic device can photograph the image pattern, and serve as a scanner when the pen moves. The pen can also touch the panel with at least one setting pattern, and exports a keyboard button signal, so as to simulate a keyboard function. The system can also include at least a detection device and a control button for use in operation.

### BACKGROUND OF THE INVENTION

1. Field of Invention

The present invention relates to an input system for coordinate and pattern. More particularly, the present invention relates to using a pen and an image fetching device to achieve the input of coordinate and pattern. The system can be used to photograph a written pattern, detect the coordinate for a movement of the pen, scan an pattern by photography, and output a representation code for a setting pattern being touched.

2. Description of Related Art

As technology of the computer information science is greatly developed, most of word file can be processed by an electronic manner. The electronic file usually needs a displaying panel to display the words on it. For example, the content of computer file is displayed through a screen. However, the word and the image pattern input by a keyboard usually has a fixing size and pattern. When a user wants to directly write words and pattern, the use needs to input by another manner, such as mouse, so as to input the words, including the sequence of the strokes, length, and direction, which are the fundamental elements of an pattern. The pattern includes, for example, any word or image pattern.

Even through the function of wording and drawing have currently been greatly improved, it still has many limiting conditions for the user to directly write world and drawing pattern. Therefore, it needs a touch panel to proceed through hand inputting or control the computer. The touching location on the touch panel is determined by the detecting resistors and detecting capacitors formed on the touch panel. Or, the touch location on the computer can be determined by infrared scanning device around the computer.

Recently, it also has an optical mouse for uses. The optical mouse can move on a reference plane with an pattern, such as desk surface. It includes a reflection photodetector, and use CCD device to fetch the pattern, The scan speed is about 1500/sec to compute the movement, so as to control the movement of the cursor.

### SUMMARY OF THE INVENTION

The invention provides an input system of coordinate and pattern, which combines functions of touching pen and camera and associate with a panel that with a set pattern. The invention includes the functions of a camera, the coordinate x, y, z detection function for a touch panel, the coordinate x, y, z detection function for a digitalized board, function of keyboard touched by the pen, function of mouse, function of scanning on image pattern, and function of detecting moving coordinate on the displaying panel in alignment at a distance. In addition, the pen can actually write or drawing, wherein the image pattern elements including movement of the pen, the sequence of the strokes, line information, color, direction, and so on. The system of the invention can photograph the pattern input and coordinate input and then exports to a computer.

The invention provides an input system of coordinate and pattern. The system can move to write or draw a pattern on a computer with the liquid crystal display (LCD) panel, CRT terminal, or projector screen, wherein the touching coordinate can be stored and exported, control button signal can be exported, and the computer cursor is controlled.

The invention provides an input system of coordinate and pattern. The system can be aligned in a distance to computer screen, LCD panel, CRT terminal, or projector screen, so as to move for writing words or drawing a pattern, inputting the written coordinate, and outputting signal to control the computer cursor.

The invention provides an input system of coordinate and pattern. The system allows to actually write and draw a pattern on a panel or a paper, which includes at least one setting different pattern. The system can input and stored coordinate of touching point and the written line including line width, color, stroke, direction, location, so as to export to a printing device or computer displaying. The system can stored and export the written or drawn pattern.

The invention provides an input system of coordinate and pattern. A document can be disposed on or aside of a panel with at least one different setting pattern, or on a desk surface. The panel includes LCD panel. The pen can move with touch or with a distance, so as to scan the image pattern on the document. Moreover, the system has function to store or export the pattern.

The invention provides an input system of coordinate and pattern. The system can move with pen touching on a panel that has at least one different setting pattern. The system then exports the coordinate of the pen under moving, the moving distance of the pen, and the control signal from a button. The system also controls the cursor, simulates function of the digitalized board, and simulate function of mouse.

The invention provides an input system of coordinate and pattern. The system can touch on a panel that has at least one different setting pattern, so as to photograph the setting pattern, discern the setting pattern, store and export an representation code for the setting pattern touched by the pen, and simulate function of the keyboard.

The invention provides an input system of coordinate and pattern. The system can perform an actual writing on a paper or a whiteboard, and then store and export the written line about the pattern elements of line width, color, stroke, direction, location.

The invention provides an input system of coordinate and pattern. The system includes a pen and a photographic device affixed on the pen. The pen touches on a panel at a detecting point a, which can be located within a photographic image region or at the periphery. The tip of the pen can be set out of the photographic image region, or the tip of the pen can be set within the photographic image region. The photographic device can photograph in the photographic image region on the displaying panel, or a panel or paper with at least one different setting pattern by the photographic image region. The system can also associate with a control unit to have the pen which touches and moves on the displaying panel with different setting pattern, or on the panel with at least one different setting pattern, or writes on a paper with at least one different setting pattern. The different setting pattern has different panel coordinate and different pattern shape. When the system photographs the panel, the photographic image region includes at least one setting pattern, the setting pattern can be discerned, and the panel coordinate of the setting pattern within the photographic image region can be known. According to the coordinate of the setting pattern within the photographic image region, a relative position of the setting pattern in the photographic image region can also be discern and analyzed out, so as to determine the panel coordinate of the photographic image region on the panel. In addition, it can be analyzed to know the panel coordinate and the moving speed and direction of the touching point a. Thereby, the coordinate detecting system can touch and move on the panel and exports the moving coordinate (x, y) of the writing and drawing to a computer for further controlling the cursor of the computer. It can also simulate the digitalized board and coordinate detection on the touch panel.

The pen of the invention has function of retraction and extension. The change of pen in retraction or extension within the photographic image region can be detected to provide the z coordinate, can also detect whether or not the tip of the pen touch the panel. The coordinate detecting system can also include a control button, such as a mouse control button, to perform the control action in operation. In addition, it can also includes at least one detection button to detect whether or not the pen has touched the panel, a displaying unit to display the operation status or the responded information from the computer. Moreover, the system can also include a recording and voicing device, used to reflect the operation status or the responded information from the computer. Further still, it can be done in a wire manner or a wireless manner to transmit the computer information.

Moreover, when the system performs the actual writing and drawing on a panel or paper with at least one setting pattern, the system can also store and export the coordinates with respect to the writing and drawing action. The photographic device can take and store the image pattern and color in writing and drawing. The coordinating system can also include at least one detection button to detect whether or not the pen has touched the panel, a displaying unit to display the operation status or the responded information from the computer. Moreover, the system can also include a recording and voicing device, used to reflect the operation status or the responded information from the computer.

Thus, the coordinate detecting system can use the pen to touch the displaying panel that displays different setting patterns or a panel with at least one setting pattern. The system can detect the setting pattern and get the assigned representation code, so as to export to a computer and simulate touching keyboard for outputting key signal function. The coordinating system can also include at least one detection button to detect whether or not the pen has touched the panel, a displaying unit to display the operation status or the responded information from the computer. Moreover, the system can also include a recording and voicing device, used to reflect the operation status or the responded information from the computer.

Moreover, the photographic device can take the image pattern, whereby the pen can writ in a usual paper. The system discerns the image pattern written by the pen on the paper, and sets the image pattern as an reference coordinate, so that the handwriting can be recorded. When the pen writes on the paper and lifts from the paper between the strokes, the photographic device still takes the image pattern, whereby the displacement of the pen, the moving speed and direction can be analyze out by analyzing the difference between the tip of the pen and the previous handwriting, so that a rough position of the pen tip is known. When the pen starts the next stroke, the system export a rough relative coordinate between the previous stroke and the new stroke. The new stroke is set to the new reference coordinate. As a result, the pen can write on the usual paper. The writing information of color thickness, stroke, relative coordinate of the stroke to the computer can be stored. However, the working condition requires that the distance between two strokes should be less than the detectable range of the photographic device. The coordinating system can also include at least one detection button to detect whether or not the pen has touched the panel, a displaying unit to display the operation status or the responded information from the computer. Moreover, the system can also include a recording and voicing device, used to reflect the operation status or the responded information from the computer.

Moreover, the photographic device can take the image pattern, wherein a document is disposed on an LCD panel, on a panel with setting pattern, or on a usual panel. The photographic device takes the setting pattern and the document. According to the displacement of the setting pattern or the document, the position, the moving speed, moving direction of the photographic device can determined, so as to serve as a scanner. According to the covered area of the document on the setting pattern and a relative position of the document on the setting pattern, so as to determine the size and position of the document, or the given document size and the position. It can take the whole document from a distance. It can move the photographic device from a periphery to the document for scanning the document. It can used the taken setting pattern to judge the location of the photographic device in panel, so as to start and stop the take the image pattern of the document. The starting and stopping point of take image pattern can also be set by hand. It can also scan the document through the pen touching and moving on the document, wherein a fixing photographic image region, such as 3×3 cm², is used to scan, so as to easily known the scanning size.

The invention also provide method for controlling a computer cursor or writing/drawing on a displaying panel of an LCD panel, a CRT terminal, or a projection displaying panel. The displaying panel is controlled by a control unit. The control unit can control the display of written/drawn pattern on the displaying panel, and know the absolute coordinate and shape of the pattern on the panel. The method comprises providing a photographic device, which is couple to the control unit and can photograph the displaying panel by a photographic image region and can discern an assigned pattern on the displaying panel assigned by the control unit. The assigned pattern is controlled by the control unit with the known panel coordinate of (x, y) and paten shape. The method analyzes the image pattern within the photographic image region, so as to judge the position, size, and shape of the assigned pattern on the photographic image region and control the assigned pattern to move together with the photographic image region, so that the assigned pattern is always shown within the photographic image region. For example, the assigned pattern is located at a center of the photographic image region and the relative position of the photographic image region to the assigned pattern is obtained. As a result, when the system moves, it can also control the assigned pattern to move. The assigned pattern includes, for example, a computer cursor for operating the computer. When the pen touches the panel, it can be controlled to have the assigned pattern to be close to the touch point of the pen. For example, it is located at the lower center point of the photographic image region. In this manner, the relative position on the panel between the assigned pattern and the touching point of the pen can be obtained. Even if the photographic device is rotated or tilted, it still can move the assigned pattern according to its shape with analysis, such as the shape orientation or shape change.

When the pen touches the panel or operated at a distance, the photographic device can point to the displaying panel and obtain a relative position between the photographic image region and the assigned pattern or a relative position between the touching point of pen and the photographic image region, so as to export the writing/drawing coordinate and operate the movement of cursor. An operating button signal can also be exported to the computer. The pen tip can be taken within or out of the photographic image region. When the pen touches the panel, the pen tip a can be set to very close to the assigned pattern, so that the touching point on the panel at the (x, y) coordinate can be obtained. The pen of the invention also has function of extension and retraction. The length change of pen tip within the photographic image region is detected, so as to provide the z-coordinate. It can also be detected whether or not the pen tip has touched the panel.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIGS. 1A-1B are perspective drawings, schematically illustrating the coordinate detection system, according to one preferred embodiment of this invention;

FIG. 1C is a perspective drawing, schematically illustrating the coordinate detection system that has the retractable pen, according to the preferred embodiment of this invention;

FIG. 2 is a cross-sectional view, schematically illustrating the coordinate detection system, according to the preferred embodiment of this invention;

FIG. 3 is a drawing, schematically illustrating the mechanism of alignment between the detection point a and the setting pattern, according to the preferred embodiment of this invention;

FIGS. 4A-4B is a drawing, illustrating the setting patterns, according to the preferred embodiment of this invention;

FIG. 4C is a drawing, illustrating a setting pattern with design using invisible setting pattern, according to the preferred embodiment of this invention;

FIG. 4D is a drawing, illustrating a displaying panel with a setting pattern, according to the preferred embodiment of this invention;

FIG. 5 is a drawing, schematically illustrating the mechanism while the pen is moving and the change of image pattern taken by the photographic device, according to the preferred embodiment of this invention;

FIG. 6 is a drawing, schematically illustrating the operation mechanism between the detection point and the setting pattern, when its is at a distance, according to the preferred embodiment of this invention.

FIGS. 7-8 are drawings, schematically illustrating the mechanism of coordinate setting, according to the preferred embodiment of this invention;

FIG. 9 is a drawing, schematically illustrating the mechanism for writing on a plain paper; and

FIG. 10, is a drawing, schematically illustrating the scanning mechanism, according to the preferred embodiment of this invention.

### DESCRIPTION OF THE PREFERRED EMBODIMENTS

The features of the invention is a coordinate detection system including a pen and a photographic device affixed on the pen. The invention can be used on, for example, an LCD panel, a CRT monitor, a displaying panel of projector, a panel with at least one different setting pattern, or a paper with at least one different setting pattern.

The function of image displaying on the displaying panel is controlled by a control unit. The photographic device can photograph the panel or paper by a photographic image region, and can be connected to a control unit. According to the coordinate of the at least one setting pattern within the photographic image region, the setting pattern is discerned, whereby the coordinate of the photographic image region is obtained. According to the at least one setting pattern within the photographic image region, the image pattern can also be analyzed to obtain the pen displacement, speed, and direction. In this manner, the coordinate detection system can write/draw on a panel or operate the computer cursor. The coordinate detection system can also be called as an coordinate input system for any other unit needing the coordinate. The pen of the invention is extendable and retractable. By detecting the change of the pen tip within the photographic image region, the z-coordinate can be obtained. In addition, the photographic device can photograph the image pattern. According to the touching point of the pen, the invention can also simulate a keyboard in use. The coordinate detection system can further include at least a detection button to detect a touching status when the touching action is desired. Moreover, the invention can also include a displaying device to display the operation status or the information in communication with the computer. Furthermore, the invention can include at least a recording and voicing device for indicating the operation status or the information in communication with the computer.

For the operation of the invention, an example is illustrated for descriptions as follows.

### EXAMPLE 1

An image pattern is shown on a computer screen. Using the imaging analyzing method, it achieves the detection of displacement of photographic device at a distance, or touching coordinate on the computer displaying panel, or on the at least one different setting pattern of the panel.

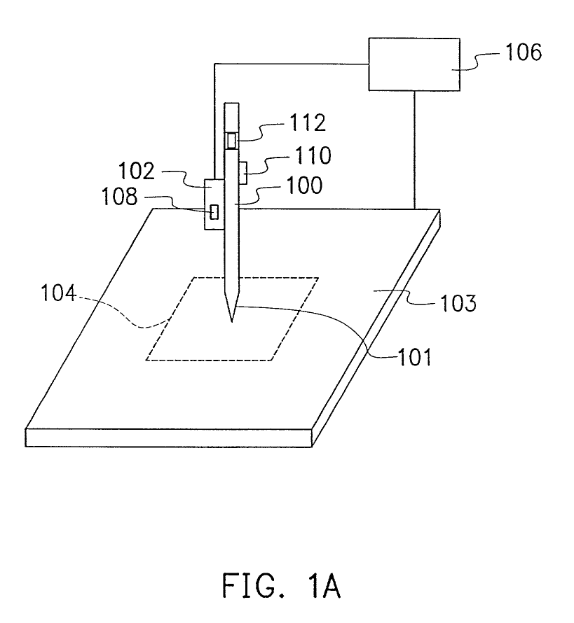

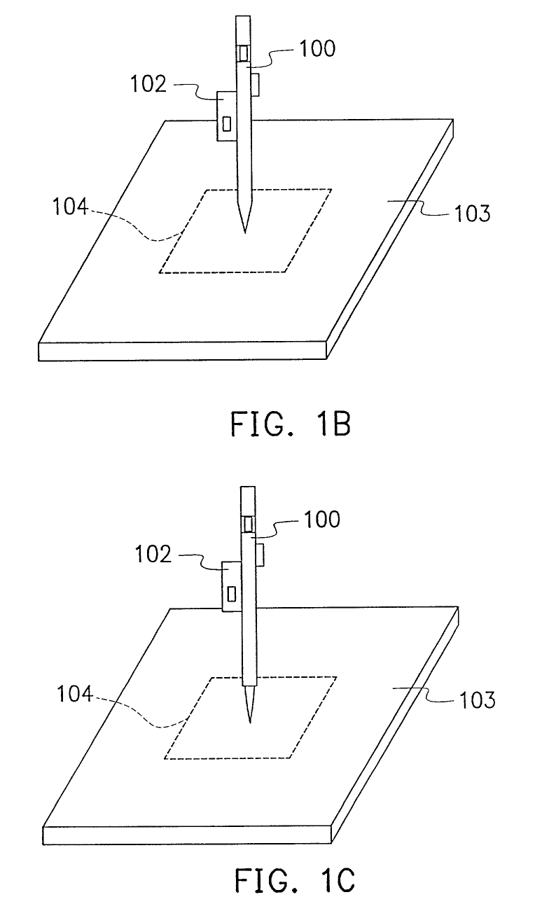

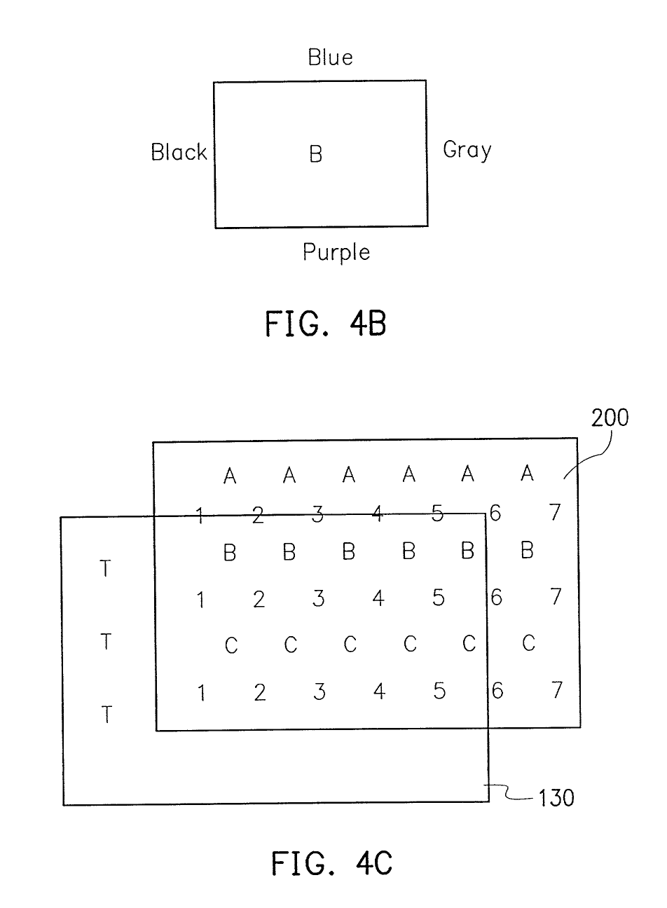

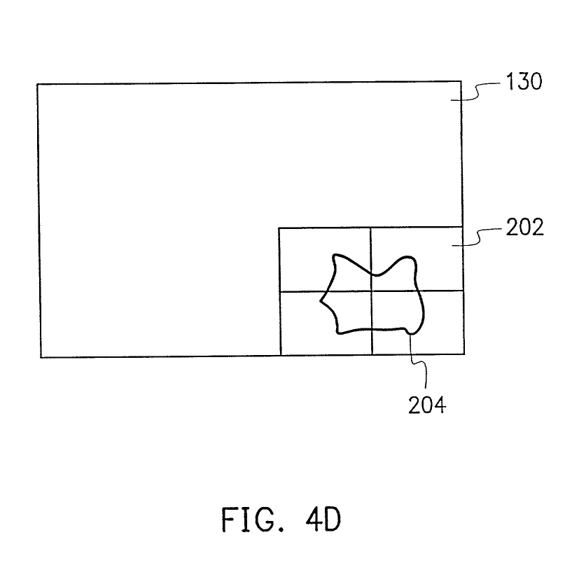

The invention uses a photographic device associating with a pen to touch the panel. In FIG. 1A, the coordinate detection system includes a pen 100, a photographic device 102, such as a camera 102, disposed on the pen 100 and has a predetermined distance from the pen tip 101, such as 3 cm. Here, the pen 100 can be a usual rod-like protrusion part or an actual pen that can actually draw. Also referring to FIG. 4D, the displaying panel 130 has a region including at least one setting pattern 202. The camera 102 photographs the displaying panel 130 with a photographic image region 104 (also see FIG. 1A), which is also, for example, 3×3 cm². The size of the photographic image region can be changed when the distance from the displaying panel is changed. A graph or word 204 within the photographic image region 104 will be photographed. The photographic device 102 can also be connected to a control unit 106 by, for example, a wire manner or wireless manner. The control unit 106, such as the computer main board circuit, also controls the displaying panel 103.

When the pen tip 101 touches the panel 103, the touch point on the displaying panel 103 has a relative panel coordinate on the panel 103 to the photographic image region 104. The photographic image region 104 can photograph at least one setting pattern used for image analysis in, for example, coordinate, size, color, and shape, so as to obtain the coordinate of the photographic image region 104 on the displaying panel 103. For example, the left lower corner of the photographic image region 104 on the panel 103 has a coordinate (X=2, Y=2) and the right upper corner has a coordinate of (X=5, Y=5) on the panel 103. As a result, the displacement and direction of the photographic device are obtained. The control unit 106 knows and controls the control parameters during operation.

In addition, the control unit can be built-in in the photographic device 102, such as the control unit 108 as shown in FIG. 1A. the photographic device 102 and the control unit 108 are connected. The control unit 108 perform image analysis to obtain the coordinate. It can also, for example, communicate with the control unit 106 by a wire manner or a wireless manner. The control unit 106 includes, for example, a computer, which also control the displaying panel 103.

In order to control the pen to write, the photographic device 102 can be implemented with at least a control button 110, such as the button used to control the pen to stop or start to write, or a mouse control button. In addition, the photographic device 102 can also include a detection button 112, such as a pressing switch, to detect whether or not the pen has touched the panel. No matter whether the button or the pressing switch, the detection button 112, serving as a touch determining device, in function generally is to detect whether or not a touch has occurred, and can determine if the writing starts. Further still, as shown in FIG. 1C, the pen tip 101 is retracted within the photographic image region 104 due to the touch on the panel. This provides the z coordinate and it is also a type of a touch determining device.

In FIG. 1A, the displaying panel 103 can be controlled by the control unit 106 for displaying the setting pattern. However, if the panel is, for example, digitalized board, printed paper, or a usual plain paper, the panel needs not the control unit 106. In FIG. 1B, a panel 103′, which can be a digitalized board, a printed paper, or a usual plain paper, needs no a control unit 106 to control image pattern.

In FIG. 4C, the setting pattern 200 can be designed to be a material sheet, which is transparent for the visible light from the panel, but the invisible light is blocked, so as to form the at least one setting pattern 200 disposed on the panel 130, with respect to the invisible light. It can be achieved due to the size, thickness, or specific choice of the material. The user cannot see the setting pattern 200 (such as A, B, C, . . . , 1, 2, 3, . . . ). However, the user can see the image pattern, such as T, shown on the displaying panel 130. The photographic device 102 can emit invisible light and detect the at least one setting pattern 200, so as to obtain the coordinate (x, y).

In FIG. 1C, the setting pattern 200 can also be designed to have the material that allows the visible light to pass but absorbs the invisible light, so as to form the at least one pattern 200 disposed on the panel 130. The user cannot see the setting pattern 200. However, the user can see the image pattern shown on the displaying panel 130. The photographic device 102 can detect the at least one setting pattern 200, so as to obtain the coordinate (x, y).

Moreover, the photographic device 102 can also have storing function to store the written image pattern and a voice. The stored information can be exported later.

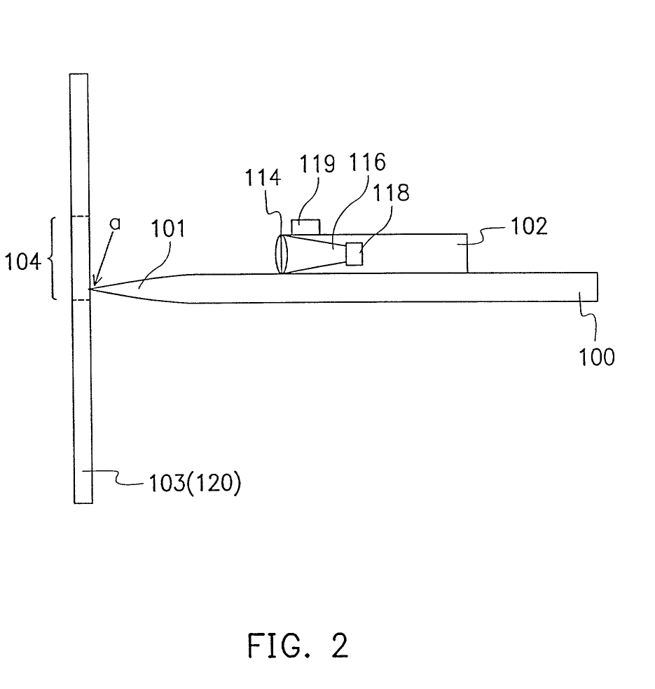

FIG. 2 is a cross-sectional view, schematically illustrating the coordinate detection system, according to the preferred embodiment of this invention. In FIG. 2, the photographic device 102 is mounted on the pen 100. The photographic device 102 include, for example, a lens 114, an optical path 116, and a digital image forming device 118, such as CCD device. In addition, it can also include a light source 119 that can actively illuminate the photographic image region 104. Since the photographic device 102 has an open angle to photograph the image, the pen tip 101 of the pen 100 can be photographed in or not photographed in. The pen tip 101 can serves as an absolute detection point of the photographic device 102 or a relative referencing detection point. How ever, the pen tip 101 is not absolutely needed. It can be optionally chosen according to the actual design or operation. The pen tip 101 touched the panel at the point a, which can serve as a detection point. The point a within the photographic image region 104 can be a point or at the periphery and has a relative position to the photographic image region 104.

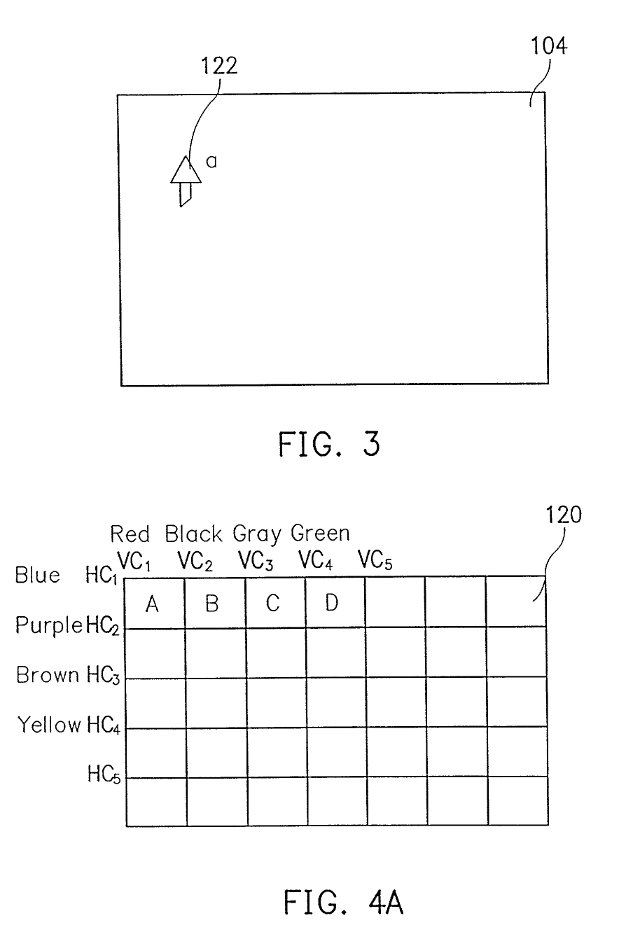

In FIG. 4D, the displaying panel 130, such as a panel having at least on setting pattern 202 at the right lower corner. The displaying panel is connected to the control unit 106. The pen touches the panel 103 at the right lower corner or writes on paper 120 having at least one different setting pattern. In this situation the display panel 103 is a paper 120. In FIG. 3, each different setting pattern has a different coordinate. When the pen touch the panel, the photographic device with a fixing photographic image region 104 to photograph the at least one setting paten, such as the setting pattern 122, located, for example, 1 cm above the touching point of the pen. Shape and location of the setting pattern 122 within the photographic image region 104 are detected. After analysis, location, moving speed, and moving direction of the detection point a of the pen 100 at the paper 120 can be known.

Thereby, the coordinate detection system can touch and move on the paper 120, and exports the coordinates of writing/drawing behavior to the computer or controlling the computer cursor. Moreover, the pen tip 101 can be retracted or extended, as shown in FIG. 1C. According to the location change of the pen tip 101 within the photographic image region 104, the z-coordinate is provided.

Furthermore, when the pen 100 actually writes or draws on the paper 120 that has at least one setting pattern, it not only exports the coordinates of writing/drawing behavior, but also photograph the drawn line, color from the photographic device 102. The coordinate detection system can further include at least one control button 110, to perform the necessary control of operation. The coordinate detection system can further include at least one detection button 112. The detection button 112 can be a button being able to detect whether or not the pen touch the paper. In addition, the system can also include a displaying device, for displaying the operation status or the response information from the computer. It can also include a voice communication device for transmitting the information from the computer by a wire manner or wireless manner.

In FIG. 4A, the paper 120 has the setting patter, such as a grid like pattern composed by several horizontal lines and vertical lines. Each grid has a specific coordinate. Each of the horizontal lines and vertical lines has also a specific address, such as the color code. It is further shown in FIGS. 4A and 4B, wherein the color is, for example, used to distinguish the grid. For example, the lines Vc2, Vc3, Hc1, and Hc2 form a grid, which has a representation code, such as 20H with respect to a coordinate (X, Y) given on the paper. In this manner, the pen can write or draw any an image pattern on the paper. In addition, the grid paper can be used to simulate a keyboard. For example, the grid also represents a character B. When the grid B is touched, the simulated keyboard B is exported.

The invention can write on an LCD panel or a CRT monitor, which can display the setting pattern. The invention can also detect the coordinate on the panel with different setting pattern, so as to control the computer cursor, simulate the digitalized board, simulate the touch panel for coordinate detection. The invention even can write on a panel that has different setting pattern, so as to export the drawn line coordinate, line width, color, stroke, direction, and location. The pen 100 can be an actual pen for writing or a pen-like without actual writing. All the stroke, color, and width can be photographed by the photographic device 102 for stored, export, or both.

The invention can write on an LCD panel or a CRT monitor, which can display the setting pattern, detect the coordinate on the panel with different setting pattern for export different information, and simulate the function of keyboard.

In the foregoing examples, it relates to operation with touch on the computer displaying panel 103 that also displays the setting patterns and are photographed. When the referencing pattern 122 (see FIG. 3) is not located within the photographic device in the beginning, the invention further provide another method to locate the coordinate. The foregoing photographic image region 102, optionally associating with the pen 100, can also be used to perform writing on the computer window and control the cursor.

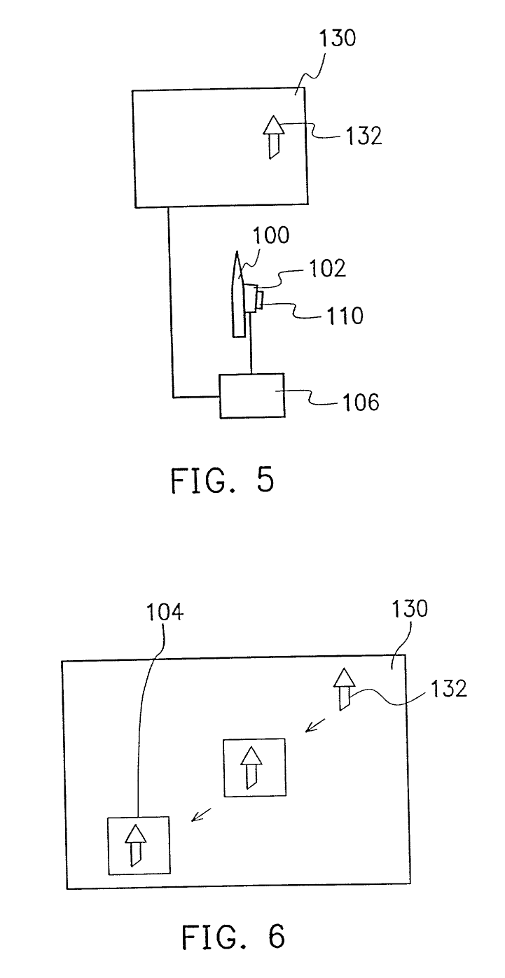

In FIG. 5, it may have only a cursor 132 on the displaying panel 130. The cursor 132 on the displaying panel has its absolute coordinate and pattern known from the control unit 106. The initial location of the cursor 132 may is not located at the center of the displaying panel 130, and for example, located at the corner. Since the absolute coordinate of the cursor 132 and the pattern of the cursor are known, it can serve as a referencing point for the move of the pen 100.

In FIG. 6, the pen 100 is about aligned to the central region of the displaying panel 130. The system activates by pushing a button 110. After pushing the button, the cursor 132 is automatically moved to the central region of the panel 130 and the initial coordinate setting is done. In this situation, the cursor is located within the photographic image region. Here, this action is also called a lock of the cursor 132. After the initial setting, the cursor 132, through the control from the control unit 106, can move together with the photographic device 102 and remain within the photographic image region 104 at about the center region. When distance between the pen 100 and the displaying panel 130 increases, the range of the photographic image region 104 can increase accordingly. This allows the more probability to lock the cursor 132.

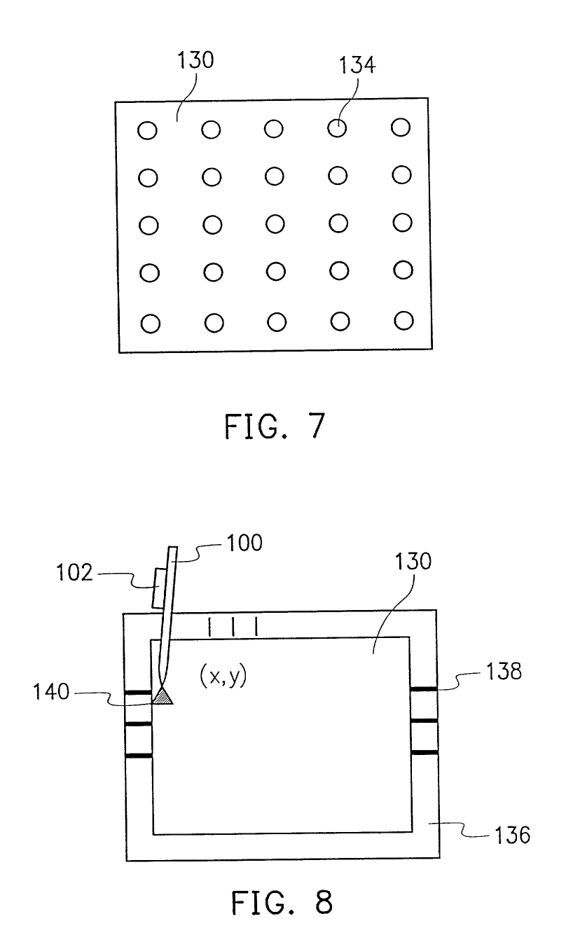

When the pen 100 starts to move, for example, the photographic image region 104 is moved to the left lower corner, the cursor 132 is not located at the center region of the photographic image region 104. However, the control unit 106 can analyze the cursor 132 within the photographic image region 104 to know the coordinate and size of the photographic image region 104 and a relative location of photographic image region 104 to the cursor 132. The cursor 132 can also move with the photographic image region 104. For example, when the photographic image region 104 is moved to the left lower corner, the cursor 132 is also moved to the left lower corner within the photographic image region 104 near the center region. For the general operation, the cursor 132 can be also a setting pattern, which can vary according to the actual design option. The foregoing initial action is also not the only manner. In FIG. 7, during initial correction stage, one or more reference pattern 134 at different locations can be generated. The reference pattern 134 like the cursor 132 has the known absolute coordinate on the panel. The reference pattern 134 can also provide the relative reference points when displacement is made. When the pen 100 enters the displaying panel 130 can first pass the reference pattern 134. The reference pattern 134 can be generated when the pen 100 may touch the panel but before locking the cursor or the initial stage is activated. In this manner, the location of the photographic image region 104 can be known. Through the control of the control unit 106, the cursor 132 may remain within the photographic image region 104 at the center region, that is the lock. The photographic device then can start move. The reference pattern 134 can be displayed on the screen or panel of the computer for, i.e., 1/60 seconds. At this condition, it would not be significantly sensed by eye. In the practical situation, the movement of the cursor is not absolutely needed. Alternatively, the pen can approach to the cursor 132 and lock the cursor. A light or voice can be used to indicate the success of lock. In this situation, the current location of the cursor is used as the relative reference point.

Since the cursor 132 can move along with the system of the invention, the invention can also serve as a pointer, to control the movement of the computer cursor for operating the computer. The pen 100 may also not be necessary in the distant operation. However, when the pen 100 is used to touch the panel, the cursor 132 can be set to be consistent with the touch point of the pen tip 101, so that the absolute coordinate of the touch point of the pen tip 101 on the panel 130 can be known. The user can uses the touch point of the pen tip 101 as the reference point, and improve the feeling for the user.

Moreover, the it is not the only choice for locating the coordinate by the cursor 132. In FIG. 8, user can also use the pattern 138 on the rim 136 of the displaying panel 130 as a reference point. The location with its coordinate of the pattern 138 is fixing and known. When the pen or photographic image region 104 enters the displaying panel 130, it can first pass the pattern 138, so as to know the coordinate of the pen or the photographic image region 104. It then can produce a setting paten 140 with its absolute coordinate on the displaying panel 130. Coordinate of the pen 100 or the photographic image region 104 is then known. In addition, the moving direction of the photographic image region 104 can be analyzed out and used for generating position of the setting pattern.

### EXAMPLE 2

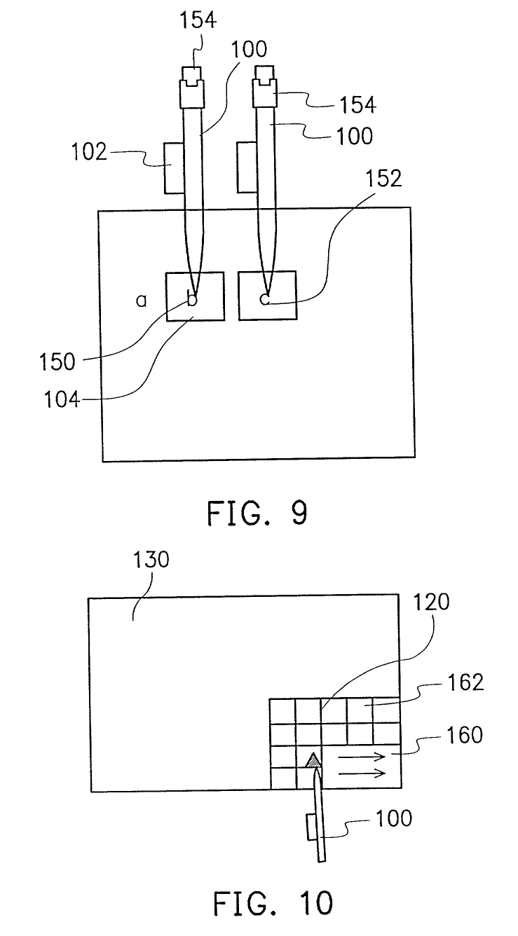

Moreover, the photographic device 102 can photograph and discern the pen tip 101 and the image pattern around the pen tip. In the invention also includes functions of storing and exporting the actual image pattern actually written or drawn by the pen. The pen tip 101 can move along with the pattern desired to be written or drawn. In FIG. 9, the photographic device 102 can photograph the image pattern, and can be used in a usual paper, so as to discern the image pattern written on the paper. The image pattern 150 is set to be a reference coordinate and then the stroke is recorded. The pen may leave form the paper and leave between two strokes. However, the pen still can photograph the image pattern 150. After analyzing the previous handwriting, the displacement, speed, direction of the pen 100 can be determined. By analysis, a relative distance between the pen tip 101 and the previous handwriting 150 can be figured out and the about coordinate of the pen can be known. When the pen 100 starts the next stroke, a new handwriting 152 is input to the system. The handwriting 152 is set to be a new reference coordinate. Thus, the pen can write a usual paper, such as a plain paper. Then, the written information, such as color, line width, stroke, reference coordinate, is exported to the computer. The information can be stored and exported later. In this application, the distance between two strokes should be not to far from the photographic image region 104. The input system of coordinate and pattern can further include a detection button 154. The detection button or any detection device can detect whether the pen touches the paper. No matter it is a button or a switch, the detection button 154 in general is a touch determining device. The pen starts to write when the pen touch the paper. Further still, it can also include a displaying device to display the operation status or the information responded from the computer. Further still, it can include at least one recording and voicing device for expressing the operation status or the information responded from the computer. It can also include a communication device for communicating with the computer by wire manner or wireless manner.

### EXAMPLE 3

The invention is directed to an input system for coordinate and pattern, which includes a pen and a photographic device. The photographic device is mounted on the pen. The displaying panel 103 is controlled by a control unit 106. The photographic device 102 can photograph any pattern on the displaying panel 103 by a photographic image region 104 and can be also coupled to the control unit 106. According to the coordinate and size of at least one setting pattern within the photographic image region 104, the coordinate and the size of the photographic image region 104 of the system can be obtained. In FIG. 10, since the photographic device 102 can discern the image pattern within the photographic image region 104, location and size of a document 160 located on the panel 130 can be together accordingly detected out. The pen 100 can scan the document 160 by a touching scanning manner with a fixing size of the photographic image region 104.

The invention has the scanning function. When the document 160 is disposed on an LCD panel 130 or on a panel having setting pattern, the system can photograph the document 160, which is to be scanned, by moving from the side of the document 160 to the document 160. The system can also photograph the document 160 by a distance with alignment to the document 160. The document 160 has image pattern to be scanned. The image pattern means any words, drawings, or printed pattern. During the scanning mode, the writing mode is set to be off, however, the photographing function still remains.

Usually, size of the document to be scanned is not known but the scanning function has its property to reflect the actual size. For example, when faxing, the actual size can be transmitted. In FIG. 10, when scanning, the document 160 can be disposed on the panel 130. The panel 130, for example, is the LCD pane. For easy operation, a corner of the panel 130 can be assigned as a special region 162 for scanning. The pattern is similar to the FIG. 4A having the grid structure 120.

The size and absolute coordinate of the grid can be known, according to the coordinate system of the displaying panel 130. Because of this, when the document 160 to be scanned is the disposed on the specific region 162, the relative location and size to the setting pattern can be photographed by the photographic image region 104 and analyzed out. When the pen tip 101 scans over the word or any image pattern on the document 160, the image pattern is inputted to the control unit 106. The size and location of the document 160 can be set by hand or the determined by the setting pattern 120. According to the covering range of the document on the setting pattern 120, the size and location of the document 160 can be determined.

Moreover, when scanning, the pen 100 can move back and forth. The pen 100, for example, can move back to the left side as the initial point. In this situation, for example, the button on the pen 100 can serve as a starting switch for each time of scanning. Alternatively, the image analysis for the image photographing on the setting pattern 120 can be performed to determine the coordinate of the photographic image region 104, so that the pen 100 is assured to have moved back to the initial scanning point of the document 160 and ready for the next scanning portion.

Furthermore, when the photographic device 102 points to the document 160 in a distance, the whole document and the setting pattern can be photographed. The location and size of the document 160 can be determined by analyzing the covered area on the setting pattern 120.

Further still, the document 160 can be disposed on a plain paper without setting pattern. The pen touches and moves and photographs by the fixing photographic image region 104. A switching manner is used to start and stop the scanning. The size of the document can be set by hand. In the invention, the moving direction and speed of the document 160 photographed by the photographic device can be analyzed to judge the moving direction and speed of the photographic image region 104, and then to judge the relative location between the photographic image region 104 and the document 160. Several pieces of scanned images and be matched to reconstruct the original document 160, which is stored and exported.

The system of the invention can include at least one detection button 112. The detection button 112 can detect whether the pen touch the panel or not. Moreover, the invention can also include a displaying device to display the operation status or the information in communication with the computer. Furthermore, the invention can include at least a recording and voicing device for indicating the operation status or the information in communication with the computer. All these devices can be implemented as the external device or the built-in device according to the actual design for forming the integrated unit.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

What is claimed is:

1. An input system of coordinate and image pattern, suitable for use in a panel, the panel includes at least one setting pattern with a known coordinate and a known pattern, the system comprising:
a photographic device, comprising a lens and optional choice of a protruding structure affixed on the photographic device, wherein the lens can point to the panel to photograph by a photographic image region,
wherein when a tip of the protruding structure touches the panel at a touching point, the photographic device photograph the setting pattern on the panel, to obtain a panel coordinate of the setting pattern on the panel, and wherein a panel coordinate of the photographic image region on the panel is obtained according to the panel coordinate of the setting pattern and a location of the setting pattern within the photographic image region.

2. The system of claim 1, wherein when the photographic device moves, a displacement and a direction of the photographic image region are obtained, when the tip of the protruding structure touches the panel, a panel coordinate of the touching point on the panel is obtained, and when the touching point moves, a displacement and a direction of the touching point are obtained.

3. The system of claim 1, wherein the panel comprises one selected from the group consisting of an LCD panel capable of displaying the setting pattern, a CRT screen capable of displaying the setting pattern, a protector screen capable of displaying the setting pattern, a board with printed the setting pattern, and a paper with printed the setting pattern.

4. The system of claim 1, wherein the protruding structure comprises an actual pen to actually write, wherein a writing information comprising stroke, line width, color, and touching coordinate can be exported and optionally stored.

5. The system of claim 1, further comprising at least a detection device, used to detect whether or not the photographic device touches the panel.

6. The system of claim 1, further comprising one selected from the group consisting of an infrared communicating device and a wireless communicating device.

7. The system of claim 1, wherein touching point and the photographic image region each have relative locations on the panel.

8. The system of claim 1, wherein the setting pattern comprises a grid structure, which is composed by a plurality of horizontal lines and a plurality of vertical lines intersecting each other, and each grid is assigned with a different coordinate and a different pattern representation.

9. The system of claim 1, wherein when a document is disposed on the panel, the protruding structure can touch the document with a fixing size of the photographic image region to photograph the document, wherein a displacement and a moving direction of the photographic image region is obtained according to a displacement and a moving direction of the setting pattern within the photographic image region, whereby a relative location of the photographic image region to the document is obtained, according to a displacement and a moving direction of a document pattern within the photographic image region, and whereby the document is photographed.

10. The system of claim 1, wherein when a document is disposed on the panel, the photographic device can photograph the setting pattern for obtaining a location of the photographic device on the panel, and also photograph the document together with the setting pattern for obtaining a relative position of the document on the panel and a document size and photographs an image pattern of the document.

11. The system of claim 1, wherein the protruding structure can be extended and retracted, whereby a Z-coordinate is obtained.

12. The system of claim 1, wherein the system can store an information of the absolute coordinate and the displacement of the photographic device.

13. An input system of coordinate and image pattern, suitable for use in a panel, the panel includes at least one movable setting pattern with a known coordinate and a known pattern, the system comprising:
a photographic device, comprising a lens and optional choice of a protruding structure affixed on the photographic device, wherein the lens can point to the panel to photograph by a photographic image region, wherein the photographic device photographs the movable setting pattern on the panel, to obtain a panel coordinate of the setting pattern on the panel, and wherein a panel coordinate of the photographic image region on the panel is obtained according to the panel coordinate of the movable setting pattern and a location of the movable setting pattern within the photographic image region.

14. The system of claim 13, wherein when the photographic device moves, a displacement and a direction of the photographic image region are obtained, when the tip of the protruding structure touches the panel, a panel coordinate of the touching point on the panel is obtained, and when the touching point moves, a displacement and a direction of the touching point are obtained.

15. The system of claim 13, wherein the panel comprises one selected from the group consisting of an LCD panel, a CRT screen, and a protector screen.

16. The system of claim 13, wherein the photographic device is coupled with a control unit that control a displaying action on the panel.

17. The system of claim 13, wherein when the photographic image region of the photographic device moves, through control of the control unit, the movable setting pattern can move along with the photographic image region and remains within the photographic image region

18. The system of claim 13, wherein the touching point and the photographic image region has a relative location.

19. The system of claim 13, further comprising a detection device, used to detect whether or not the photographic image region touches the panel.

20. The system of claim 13, further comprising one selected from the group consisting of an infrared communicating device and a wireless communicating device.

21. The system of claim 13, wherein the protruding structure can be extended and retracted, whereby a Z-coordinate is obtained.

22. The system of claim 13, wherein the movable setting pattern comprises a cursor.

23. An input system of coordinate and image pattern, suitable for use in a panel, the panel includes at least one setting pattern with a known coordinate and a known pattern, the system comprising:
a photographic device, optionally comprising a lens and a protruding structure affixed on the photographic device, wherein the lens can point to the panel to photograph the panel by a photographic image region, wherein the setting pattern comprises a material which allows a visible light emitted from the panel to pass but reflects an invisible light from the photographic device, whereby the setting pattern of the material with respect to the invisible is formed,
wherein when a tip of the protruding structure touches the panel at a touching point, the photographic device can emit the invisible light to photograph the setting pattern on the panel, to obtain a panel coordinate of the setting pattern on the panel, and wherein a panel coordinate of the photographic image region on the panel is obtained according to the panel coordinate of the setting pattern and a location of the setting pattern within the photographic image region, wherein a panel coordinate of the touching point is obtained

24. The system of claim 23, wherein when the photographic device moves, a displacement and a direction of the photographic image region are obtained and when the touching point moves, a displacement and a direction of the touching point are obtained.

25. An input system of coordinate and image pattern, suitable for use in a panel, the panel includes at least one setting pattern with a known coordinate and a known pattern, the system comprising:
a photographic device, optionally comprising a lens and a protruding structure affixed on the photographic device, wherein the lens can point to the panel to photograph the panel by a photographic image region, wherein the setting pattern comprises a material which allows a visible light emitted from the panel to pass but absorbs an invisible light, whereby the setting pattern of the material with respect to the invisible is formed,
wherein when a tip of the protruding structure touches the panel at a touching point with a known panel coordinate, the photographic device can emit the invisible light to photograph the setting pattern on the panel, to obtain a panel coordinate of the setting pattern on the panel, and wherein a panel coordinate of the photographic image region on the panel is obtained according to the panel coordinate of the setting pattern and a location of the setting pattern within the photographic image region, wherein a panel coordinate of the touching point is obtained.

26. The system of claim 25, wherein when the photographic device moves, a displacement and a direction of the photographic image region are obtained and when the touching point moves, a displacement and a direction of the touching point are obtained.

27. A method for inputting coordinate and image pattern, the method comprising:
providing a panel that is controlled by a control unit, wherein the panel comprises at least one movable setting pattern with an absolute coordinate on the panel;
providing a photographic device, having a photographic image region;
photographing the panel on the movable setting pattern;
performing an image analysis, to obtain the panel coordinate of the at least one movable setting pattern and a panel coordinate of the photographic image region; and
moving the at least one movable setting pattern together with the photographic image region, and maintaining the at least one movable setting pattern within the photographic image region, wherein the control unit is used to control by using the panel coordinate of the photographic image region.

28. The method of claim 27, further comprising:
generating at least one setting pattern with a fixing coordinate for a period of time at an initial stage, for allowing the photographic device to detect a current position on the panel.

29. A method for inputting coordinate and image pattern, the method comprising:
providing a panel;
providing a pen, which can actually write or draw on the panel;
providing a photographic device, affixed on the pen; and
moving the pen to actually produce a line, wherein the photographic device simultaneously photograph the line to obtain a line information, and the line information also provide a referencing coordinate for a next produced line.

30. The method of claim 29, further comprising:
exporting a produced pattern composed of each the line, wherein the line information for each the line includes a color, a line width, a stroke, and the referencing coordinate; and
optionally storing the line information.
